(19) United States
(12) Patent Application Publication
(10) Pub. No.: US 2009/0310008 A1
(43) Pub. Date: Dec. 17, 2009

(54) DETECTION DEVICES

(76) Inventor: Shih-Huang Chen, Hsin-Chu (TW)

Correspondence Address: BIRCH STEWART KOLASCH & BIRCH, PO BOX 747, FALLS CHURCH, VA, 22040-0747, US

(21) Appl. No.: 12/184,765

(22) Filed: Aug. 1, 2008

(30) Foreign Application Priority Data
Jun. 12, 2008 (TW) 97121860

(51) Int. Cl. H04N 3/12

(52) U.S. Cl. 348/332; 348/E09.002

(57) ABSTRACT

A detection device for detecting an object image comprises a detection unit and a read-out unit. The detection unit comprises at least one detection array. The at least one detection array comprises a plurality of detection cells disposed in M detection rows, M≧2. The detection cells generate a plurality of detection signals, and the detection signals represent specific color information. The read-out unit receives the detection signals from the at least one detection array and generates an image signal according to the received detection signals.

### CROSS REFERENCE TO RELATED APPLICATIONS

This application claims the benefit of Taiwan application Serial No. 97121860 filed Jun. 12, 2008, the subject matter of which is incorporated herein by reference.

### BACKGROUND OF THE INVENTION

1. Field of the Invention

The invention relates to a detection device, and more particularly to a detection device providing various resolutions for images.

2. Description of the Related Art

In current linear detection devices, image resolution is enhanced by increasing the amount of detection pixels. Increasing the amount of detection pixels not only increases the length of the detection chips, but also increases manufacturing costs and difficulty. Thus, often, in efforts to save space, sizes of detection cells are decreased, which degrades sensitivity of the detection cells. As shown in FIGS. 1A and 1B, each detection chip has a single detection row. As the amount of detection cells (DC), that is dot counts, is increased, the vertical width and horizontal width of each detection cell DC decrease from 42 um to 21 um, such that the sensitivity of the detection cells are degraded. In some conventional detection devices, as shown in FIG. 1C, the vertical width of each detection cell is increased, and the sensitivity of the detection cells is enhanced, however, the vertical direction resolution is degraded.

Thus, it is desired to provide a detection device which can generate image signals with various resolutions.

### BRIEF SUMMARY OF THE INVENTION

An exemplary embodiment of a detection device for detecting an object image comprises a detection unit and a read-out unit. The detection unit comprises at least one detection array. The at least one detection array comprises a plurality of detection cells, disposed in M detection rows, M≧2. The detection cells generate a plurality of detection signals, and the detection signals represent specific color information. The read-out unit receives the detection signals from the at least one detection array and generates an image signal according to the received detection signals. The image signal represents the object image.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1A-1C show conventional detection arrays;

FIG. 2 shows an exemplary embodiment of a detection device;

FIG. 3 shows an exemplary embodiment of the disposition of the detection cells in the detection arrays;

FIG. 4 shows another exemplary embodiment of the disposition of the detection cells in the detection arrays; and

FIG. 5 shows another exemplary embodiment of the disposition of the detection cells in the detection arrays.

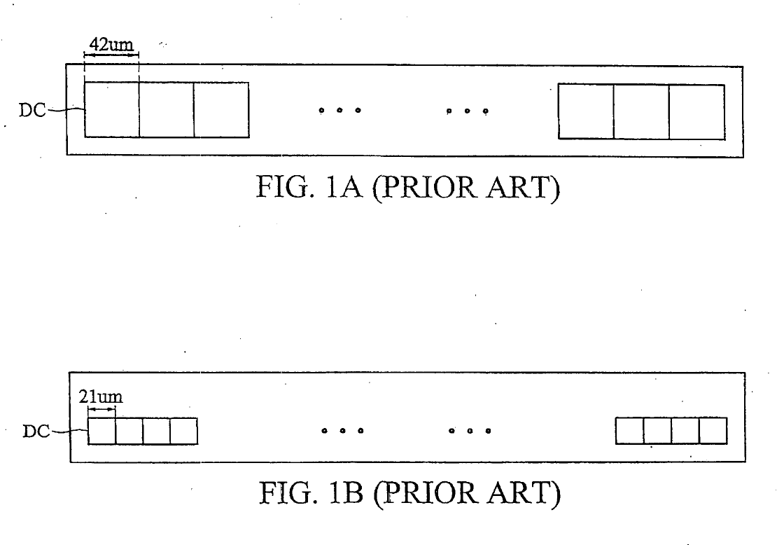

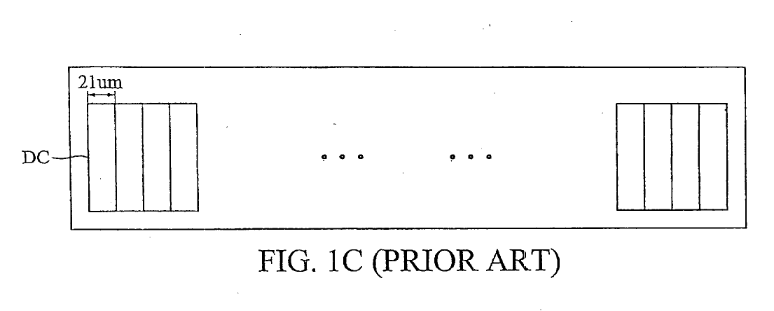

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

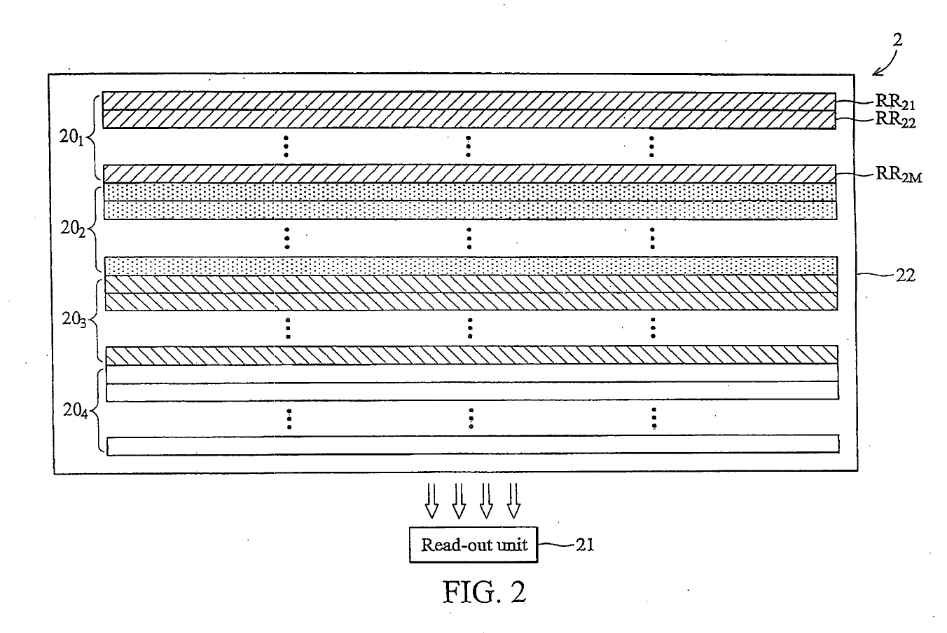

Detection devices are provided. In an exemplary embodiment of a detection device in FIG. 2, a detection device 2 comprises a detection unit 22 and a read-out unit 21. The detection unit 22 comprises at least one detection array 20. In the embodiment of FIG. 2, four detection arrays 20₁-20₄ are given as an example. Each detection array comprises a plurality of detection cells disposed in M detection rows, M≧2. Each detection array generates detection signals according reflected light from an object. The read-out unit 21 selectively receives the detection signals from at least one detection array and generates image signals representing the object image according to the received detection signals. The image signals can be analog or digital signals. In the detection device 2, the detection signals from detection arrays 20₁-20₄ represent different color information, such as red (R), green (G), blue (B), and gray levels.

For example, according to the reflected light from an object, each detection cell of the detection array 20₁ generates a red detection signal, each detection cell of the detection array 20₂ generates a green detection signal, each detection cell of the detection array 20₃ generates a blue detection signal, and each detection cell of the detection 20₄ generates a gray-level detection signal. The red, green, blue, and the gray-level detection signals represent different color information in red (R), green (G), blue (B), and gray-level.

When the read-out unit 21 receives the red, green, and blue detection signals, the image signals generated by the read-out unit 21 represent the color image of the object. When the read-out unit 21 receives the gray-level detection signals, the image signals generated by the read-out unit 21 represent the gray-level image of the object.

In FIG. 2, each array on the detection unit comprises detection cells deposed in M rows, for example, the detection cells in the detection array 20₁ are disposed in the detection rows RR₂₁-RR_{2M}. According to different dispositions of the detection cells in the detection arrays, the read-out unit 21 can generate image signals with a desired color combination and designated resolution by using a designated detection array (or designated detection arrays) and a designated read-out mode.

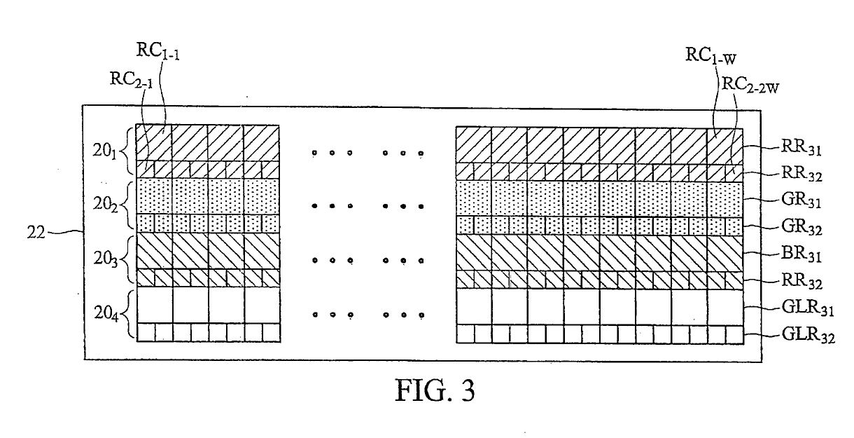

FIG. 3 shows an exemplary embodiment of a disposition of detection cells of detection arrays in a detection unit. In the following, the detection array 20₁ is given as an example for clear illustration, and the dispositions of the detection cells of the detection arrays 20₂-20₄ are the same as that of the detection array 20₁. The detection array 20₁ comprises detection cells which are disposed in M rows. X detection rows among the M detection rows detect an image of an object by a first resolution, and Y detection rows among the M detection rows detect the image of the object by a second resolution, wherein 1≦X<M, and 1≦Y≦(M−X).

For example, the detection array comprises a plurality of detection cells which are disposed in two rows, that is M=2. Referring to FIG. 3, detection cells RC₁₋₁-RC_{1-W} are disposed in one row to form a detection row RR₃₁, and detection cells RC₂₋₁-RC_{2-2W} are disposed in the other row to form a detection row RR₃₂, wherein W is a natural number. As shown in FIG. 3, the detection row RR₃₁ and the detection row RR₃₂ have the same length, and the amount of the detection cells in the detection row RR₃₂ is greater than that in the detection row RR₃₁. In another aspect, sizes of the detection cells RC₁₋₁-RC_{1-W} in the detection row RR₃₁ are larger than sizes of the detection cells RC₂₋₁-RC_{2-2W} in the detection row RR₃₂. Thus, one detection array (X=1) among the two detection arrays (M=2) detects an image of an object by a first resolution, and the other detection array (Y=1) among the two detection arrays (M=2) detects an image of the object by a second resolution, wherein the second resolution is greater than the first resolution. The read-out unit 21 can selectively receive red detection signals from the detection cells RC₁₋₁-RC_{1-W} in the detection row RR₃₁ or from the detection cells RC₂₋₁-RC_{2-2W} in the detection row RR₃₂.

When the detection device 2 desires to obtain a color image of an object the read-out unit 21 can receive red detection signals, green detection signals, and blue detection signals respectively from the detection rows RR₃₁, GR₃₁, and BR₃₁ to get a color image of the object in low resolution, or receive red detection signals, green detection signals, and blue detection signals respectively from the detection rows RR₃₂, GR₃₂, and BR₃₂ to get a color image of the object in high resolution. Similarly, when the detection device 2 desires to obtain a gray-level image of the object, the read-out unit 21 can receive gray-level detection signals from the detection row GLR₃₁ to get a gray-level image of the object in low resolution or receive gray-level detection signals from the detection row GLR₃₂ to get a gray-level image of the object in high resolution.

In the embodiment of FIG. 3, the amount of the detection cells in the detection array RR₃₂ is two times that of the detection array RR₃₁; however, the amount is without limitation.

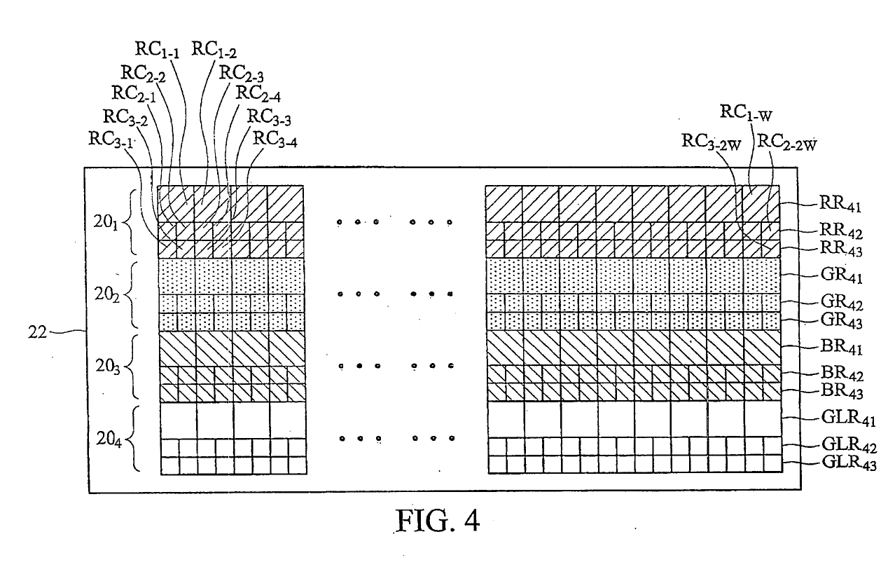

In some embodiments, as shown in FIG. 4, each of the detection arrays 20₁-20₄ comprises a plurality of detection cells which is disposed in three rows, that is M=3. Detection cells RC₁₋₁-RC_{1-W} are disposed in one row -to form a detection row RR₄₁, detection cells RC₂₋₁-RC_{2-2W} are disposed in one row to form a detection row RR₄₂, and detection cells RC₃₋₁-RC_{3-2W} are disposed in one row to form a detection row RR₄₃. The detection rows RR₄₁-RR₄₃ have the same length, and the amount of the detection cells in each of the detection rows RR₄₂ and RR₄₃ is greater than that in the detection row RR₄₁. Thus, one detection array (X=1) among the three detection arrays (M=3) detects an image of an object by a first resolution, and the other two detection arrays (Y=2) among the three detection arrays (M=3) detect an image of the object by a second resolution, wherein the second resolution is greater than the first resolution. When the detection device 2 desires to obtain a color image of an object, the read-out unit 21 can receive red, green, and blue detection signals respectively from the detection rows RR₄₁, GR₄₁, and BR₄₁ to get a color image of the object in low resolution, or receive red, green, blue detection signals respectively from the detection rows RR₄₂, GR₄₂, and BR₄₂ or from the detection rows RR₄₃, GR₄₃, and BR₄₃ to get a color image of the object in high resolution. Similarly, when the detection device 2 desires to obtain a gray-level image of the object, the read-out unit 21 can receive gray-level detection signals from the detection row GLR₄₁ to get a gray-level image of the object in low resolution or receive gray-level detection signals from the detection row GLR₄₂ or GLR₄₃ to get a gray-level image of the object in high resolution. In the embodiment, both of the color image and the gray-level image of the object can have a lower resolution. The detection array 20, is given as example. The read-out unit 21 can combine the detection signals from the detection cells RC₁₋₁, RC₁₋₂, RC₂₋₁-RC₂₋₄, and RC₃₋₁-RC₃₋₄ to generate an image signal in a lower resolution. The read-out unit 21 can perform the same operation as previously mentioned to the detection arrays 20₂-20₄.

According to above embodiments, the detection cells of the detection array in the detection unit are disposed in plurality of rows, and object images with different resolution can be obtained by the disposition of the detection cells. When the detection unit desires to detect an image of an object in high resolution, sizes of the used detection cells are smaller; however, the image detection can be performed for a longer time period to enhance sensitivity. On the contrary, when the detection unit desires to detect an image of an object in low resolution, sizes of the used detection cells are larger, and sensitivity of the used detection cells is high. The time period when image detection is performed is thus shortened. Thus, the detection device of the embodiments can obtain preferred object images by considering both image resolution and sensitivity of the detection arrays.

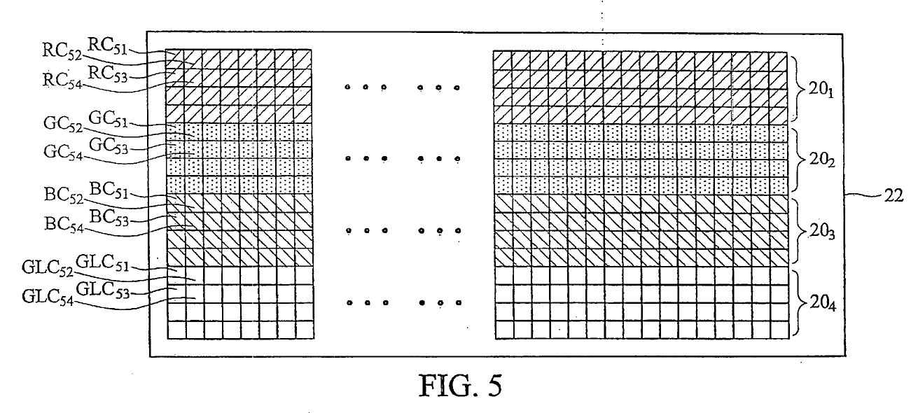

FIG. 5 shows another exemplary embodiment of a disposition of detection cells of detection arrays in a detection unit. In the following, the detection array 20₁ is given as an example for clear illustration, and the dispositions of the detection cells of the detection arrays 20₂-20₄ are the same as that of the detection array 20₁. The detection array 20₁ comprises a plurality of detection cells which are disposed in M detection rows. In FIG. 5, four detection rows (M−4) are given as example in each detection row. The read-out unit 21 gets a first amount of detection signals to serve as a resolution unit and generates image signals with a first resolution according to the resolution unit, or gets a second amount of detection signals to serve as a resolution unit and generates image signals with a second resolution according to the resolution unit, wherein the first amount is N² times the second amount, and N is a natural number. In other words, the read-out unit 21 can selectively generate image signals with different resolution according to the detection signals from the detection arrays 20₁-20₄.

For example, the read-out unit 21 gets the four detection signals (the first amount is equal to 4) from each four detection cells adjacent to each other (such as detection cells RC₅₋₁-RC₅₋₄, detection cells GC₅₋₁-GC₅₋₄, and detection cells BC₅₋₁-BC₅₋₄) to serve as a resolution unit and generates color image signals with a first resolution according to the resolution unit. When the detection device 2 desires to obtain color image signals with high resolution, the read-out unit 21 gets the detection signal (the second amount is equal to 1) from each detection cell (such as detection cells RC₅₋₁, GC₅₋₁, and BC₅₋₁) to serve as a resolution unit and generates color image signals with a second resolution according to the resolution unit. Since the area of one detection cells is smaller than the area of each four detection cells adjacent to each other, the second resolution is higher than the first resolution. According to above description, the resolution of the image signals can be gradually decreased, as the resolution unit generates image signals first from a single detection cell, next from four detection cells adjacent to each other, following from nine detection cells adjacent to each other, and next from sixteen detection cells adjacent to each other.

Similarly, for example, the read-out unit 21 gets the four detection signals (the first amount is equal to 4) from each four detection cells adjacent to each other (such as detection cells GLC₅₋₁-GLC₅₋₄) to serve as a resolution unit and generates gray-level image signals with a first resolution according to the resolution unit. When the detection device 2 desires to obtain gray-level image signals with high resolution, the read-out unit 21 gets the detection signal (the second amount is equal to 1) from each detection cell (such as detection cells GLC₅₋₁) serve as a resolution unit and generates gray-level image signals with a second resolution according to the resolution unit. Since the area of one detection cells is smaller than the area of each four detection cells adjacent to each other, the second resolution is higher than the first resolution.

According to the embodiment in FIG. 5, according to the resolution units obtained by the different amounts of detection cells, the read-out unit can generate image signals with different resolutions, so that the detection device generates images of an object with different resolutions. Moreover, when resolution units are obtained by different amounts of detection cells, the preferred sensitivity of the detection cells can be maintained by adjusting a time period for image detection operation.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A detection device for detecting an object image, comprising
a detection unit comprising at least one detection array, wherein the at least one detection array comprises:
a plurality of detection cells, disposed in M detection rows, for generating a plurality of detection signals, wherein, the detection signals represent specific color information, M≧2; and
a read-out unit for receiving the detection signals from the at least one detection array and generating an image signal, which represents the object image, according to the received detection signals.

2. The detection device as claimed in claim 1, wherein X detection rows among the M detection rows detects the object image according to first resolution, and Y detection rows among the M detection rows detects the object image according to second resolution, 1≦X<M, and 1≦Y≦(M−X).

3. The detection device as claimed in claim 2, wherein the read-out unit selectively receives the detection signals generated from the detection cells in the X detection rows or from the detection cells in the Y detection rows.

4. The detection device as claimed in claim 1, wherein the read-out selectively generates the image signal with a first resolution or second resolution according to the detection signals.

5. The detection device as claimed in claim 4, wherein the read-out unit generates the image signal with the first resolution according to a resolution unit which is obtained from a first amount of detection signals or generates the image signal with the second resolution according to a resolution unit which is obtained from a second amount of detection signals.

6. The detection device as claimed in claim 5, wherein the first amount is N² times the second amount, and N is a natural number.

7. The detection device as claimed in claim 1, wherein the detection signals represent the color information of one of red, green, and blue.

8. The detection device as claimed in claim 1, wherein the detection signals represent the information of gray levels.

9. The detection device as claimed in claim 1, wherein when the detection unit comprises a first detection array and a second detection array, the detection signals from the first detection array represent first color information, and the detection signals from the second detection array represent second color information different from the first color information.

10. The detection device as claimed in claim 9, wherein the first color information represents one of red, green, and blue.

11. The detection device as claimed in claim 10, wherein the second color information represents gray levels.

12. The detection device as claimed in claim 9, wherein when the detection unit further comprises a third detection array, the detection signals from the third detection array represent third color information different from the first and second color information.

13. The detection device as claimed in claim 12, wherein the first, second, and third color information represents red, green, and blue.

14. The detection device as claimed in claim 13, wherein when the detection unit further comprises a fourth detection array, the detection signals from the fourth detection array represent information of gray levels.
